(19) United States
(12) Patent Application Publication
(10) Pub. No.: US 2004/0199458 A1
(43) Pub. Date: Oct. 7, 2004

(54) System and method for on-line mortgage services

(76) Inventor: Thinh Ho, Fountain Valley, CA (US)

Correspondence Address: OPPEDAHL AND LARSON LLP, P O BOX 5068, DILLON, CO, 80435-5068, US

(21) Appl. No.: 10/408,373

(22) Filed: Apr. 7, 2003

(51) Int. Cl. G06F 17/60

(52) U.S. Cl. 705/38

(57) ABSTRACT

A system is provided which allows a consumer to access mortgage information and mortgage financing through a computer network. The consumer provides, via a first computer sufficient information to the second computer to allow the second computer to obtain a credit report for the specific individual consumer. This credit report is used to select mortgage programs from the mortgage program database which are actually available to the specific consumer, based on the specific consumer's credit worthiness. Information about these mortgage programs are then transmitted, preferably with one or a very few minutes, to the first computer where they are displayed for consideration by the user. Preferably, if the consumer selects one of the displayed mortgage programs, that consumer is immediately approved for the mortgage financing subject only to verification of the information provided.

### BACKGROUND OF THE INVENTION

This application relates to a system and a method for providing on-line mortgage services.

The Internet has changed the way many people obtain mortgage financing for their homes or businesses. In many cases, the basic process for obtaining a mortgage loan is essentially the same as traditional, person-to-person mortgage financing, except that part or all of the processes are conducted via electronic communications. In addition, on-line presentation may take the place of advertising.

For example, U.S. Pat. No. 6,385,594 describes a process for obtaining competitive mortgage bids for a consumer over the Internet. In large measure, this is simply making the process of shopping around easier than it would have been in the past, without the Internet. Similarly, US Published Patent Application 2001/0011245 describes an on-line consumer credit data reporting system. This system presents on-line data to allow assessments as to the credit worthiness of an individual consumer. Such reports were available prior to the availability of on-line Internet connections, but they took longer to access. Further the data might not have been as up-to-date, since input of new information could take longer.

US Published Patent Application 2002/0077964 discloses a system and method which allow a consumer to collect their own credit report on-line and make a determination of their own credit worthiness.

US Published Patent Application 2002/0091630 discloses a computerized system which acts as an intermediary to facilitate the processing of loan applications. It is, as stated, a substitute for time-consuming personal visits and shopping around for a loan.

U.S. Pat. No. 6,405,181 describes a credit approval system where credit data about a loan applicant is transmitted electronically to financial institutions, and the consumer is subsequently advised if credit has been approved.

### SUMMARY OF THE INVENTION

The present invention provides a novel system which offers a unique combination of features which were not available to a home mortgage customer prior to the availability of the Internet, and thus represents a true breakthrough in the way in which mortgage financing is obtained. In accordance with the invention, a system and method are provided for a consumer's use in obtaining mortgage financing. The system comprises a first computer located at a first location accessible to a user; a second computer system located at a second location, generally remote from the user and not directly accessed by the user, and a communications network connecting the first computer to the second computer. The second computer has access to a database of information containing credit reports on consumers who may use the system. This access can be within the second computer, as a result of the database being maintained on the second computer, or it may be access made to a database stored on yet a third computer through the same or another communications network. The second computer also has access to a database containing a listing of a plurality of mortgage programs currently available to consumers with different creditworthiness as determined by their individual credit report and other factors such as property type and location, the loan-to-value ratio etc. When a consumer uses the first computer to request mortgage financing, the first computer transmits sufficient information to the second computer to allow the second computer to obtain a credit report for the specific individual consumer. This credit report is used to select mortgage programs from the mortgage program database which are actually available to the specific consumer, based on the specific consumer's credit worthiness. Information about these mortgage programs is then transmitted to the first computer where they are displayed for consideration by the user. In a preferred embodiment, if the consumer selects one of the displayed mortgage programs, that consumer is immediately approved for the mortgage financing.

### BRIEF DESCRIPTION OF THE DRAWINGS

FIG. 1 shows a schematic representation of an embodiment of the invention.

FIG. 2 shows in greater detail a flow chart of the process done by the second computer 3 in an embodiment of the invention

FIG. 3 shows a detail view of the credit history report collection process (201).

FIG. 4 shows the process (101) of generating loan filtering parameters in greater detail.

FIG. 5 shows the process (400, 401) of generating actual loan costs in greater detail.

FIG. 6 shows the process (500, 501) of obtaining pricing adjustments in greater detail.

FIGS. 7-21 show various pages of a web-based data and information collection system which may be used in the method of the present invention.

FIG. 7 shows the opening page of the web-based data and information collection system.

FIG. 8 shows a screen in which a choice is offered between a conventional quick search and a custom search in accordance with the invention.

FIG. 9 shows the next page of the web system in which basic customer information is collected.

FIG. 10 shows the next page of the web system in which basic customer information is collected, and it also has entry fields for the creation of a user ID for immediate log in on subsequent visits.

FIG. 11 is displayed showing that the evaluation is in progress once the user inputs the information requested on the pages shown in FIGS. 9 and 10 and indicates that he or she wants to proceed with the custom rate search.

FIG. 12 shows the next screen which gives a list of available loan programs is displayed.

FIG. 13 shows the screen that results from clicking the link in FIG. 12 in the “Type” or “Product” column displays a screen. This screen provides an explanation of the particular loan product to the consumer.

FIG. 14 shows the screen that results from clicking the “View More” link in FIG. 12 in the “Available Rate Options” column. This screen provides rate and point options within the loan program, and provides an option to “apply now” and an option to print a pre-approval certificate

FIG. 15 shows a pre-approval certificate.

FIG. 16 shows the screen that results if the consumer selects “apply now” on the screen shown in FIG. 14. This screen confirms that the user's application is complete and provides contact information regarding the loan specialist assigned to the application.

FIG. 17 shows an example of the response provided to the consumer if the user inputs the information requested on the pages shown in FIGS. 9 and 10 and no loan programs are available based on such information.

FIG. 18 shows an example of the page displayed to the user that has already conducted a custom rate search in a previous session and has returned to the website and accessed the log on feature shown in FIG. 7.

FIG. 19 is displayed once the consumer enters their log on information. This screen displays all of the custom rate searches performed by the consumer.

FIG. 20 shows the screen that results from clicking the link in FIG. 19 in the “Rates” column. This screen is similar to the screen displayed to the consumer when they first performed the custom rate search (FIG. 12), however, there is one additional function-a button that invites the user to “Update Rates.”

FIG. 21 shows the screen that results from clicking the link titled “Modify your search” on the screens shown in FIG. 12 and FIG. 20, which allows the user to modify the information used by the system in performing the custom rate search.

### DETAILED DESCRIPTION OF THE INVENTION

This invention relates to a system and method for providing information about available mortgage loan programs to a consumer through an electronic communications network such as the Internet. Unlike existing programs, which only provide rates, which might be termed “teaser rates” for which many individuals will not qualify, the system and method of the present invention provide the consumer with rates for which the consumer is qualified. In specific embodiments of the invention, the system and method of the invention further provide the consumer with information about the closing costs that would be incurred to close the loan, and provide the consumer with the opportunity to apply for the loan and be immediately approved.

As used in the specification and claims of this application, the terms employed generally have their ordinary meanings. The following specific definitions are provided, however, to avoid any ambiguity.

“Mortgage” refers to financing secured by real property. It refers to both first and second mortgages, home equity loans, and home equity lines of credit.

“Mortgage loan program” refers to a mortgage offering of a particular financial institution. A “mortgage loan program” is distinguished from other mortgage loan programs by a unique combination of at least the following features: (a) the financial institution; (b) the type of mortgage (first, second, etc.); (c) the purpose of the mortgage loan (purchase, refinance, refinance with cash out etc.); (d) the type and term of the loan (for example, 30 year fixed, 15-year fixed, and adjustable rate mortgages with various terms); (e) the minimum credit characteristics required to qualify for the mortgage loan program; and (f) the location of the real property. Each distinct mortgage loan program will differ from other mortgage loan programs in at least one of these characteristics, and each distinct mortgage loan program carries with it an associated interest rate and other terms, which will vary as a function of market conditions.

“Closing costs” refer to fees paid at closing to complete the loan transaction, whether paid in cash or financed as part of a mortgage amount. Such closing costs include all lender fees (such as buy down points and fees for processing, document preparation fees, underwriting fees, credit report fees, tax service, wire transfer fees, flood certification, reconveyance and notary service) and third party fees paid by the borrower (such as appraisal fees, title insurance premiums and loan escrow fees (in the case of refinance transactions)).

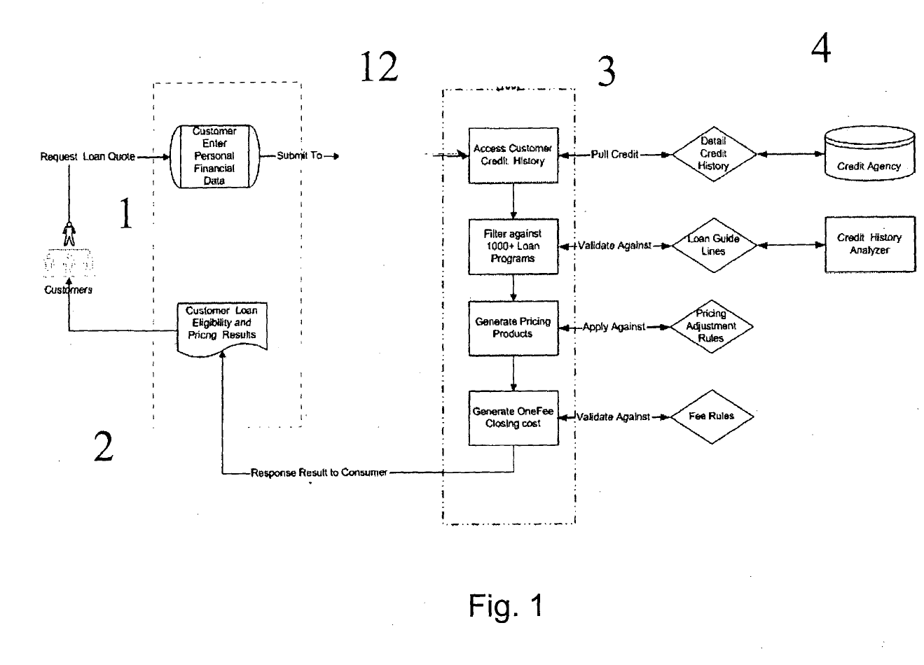

FIG. 1 shows a diagrammatic representation of an embodiment of the system and method of the invention. In accordance with the invention, a consumer 1, or a user acting on behalf of the consumer, makes use of a first computer, indicated by dashed box 2. The first computer system is connected to a second computer, indicated by dashed box 3 via an electronic communications network such as the Internet. The mechanism by which the first and second computers make connection to the communication network need not be of any particular type and may include without limitation standard telephone modem connections, ISDN, ADSL or SDSL connection, cable modem connections, satellite connections, other wireless connections, and combinations thereof.

In the first step of the invention, the customer enters personal information into the first computer, for example through a web site interface. This personal information includes sufficient information about the consumer making the inquiry about available loan rates, and about the type of mortgage and mortgage loan program desired to permit the determination of the persons' credit worthiness and to present available mortgage loan programs of the type of interest. The entered information is transmitted via the electronic communication network (arrow 12) to the second computer 3. This second computer 3 is generally at a location remote from the first computer 2 and is in any event not accessible to general consumers.

In response to the received transmission from the consumer, the second computer develops a credit worthiness rating for the consumer. In a preferred embodiment, this process includes the step of accessing a detailed credit history for the consumer. This may be accomplished, for example, by querying a third computer 4 associated with a credit reporting agency, although the credit records could be maintained on the second computer without departing from the invention. The present invention provides a first mortgage origination system that allows the borrower, prior to submitting an application, to see accurate rates and fees on loan programs for which they actually qualify. The invention employs several criteria to adjust pricing or eliminate loan programs in accordance with a borrower's individual characteristics, including but not limited to loan to value ratio, low documentation versus full documentation of financial status, employment status, whether the mortgage sought is a “cash-out” mortgage, location of property, size of loan and occupancy status.

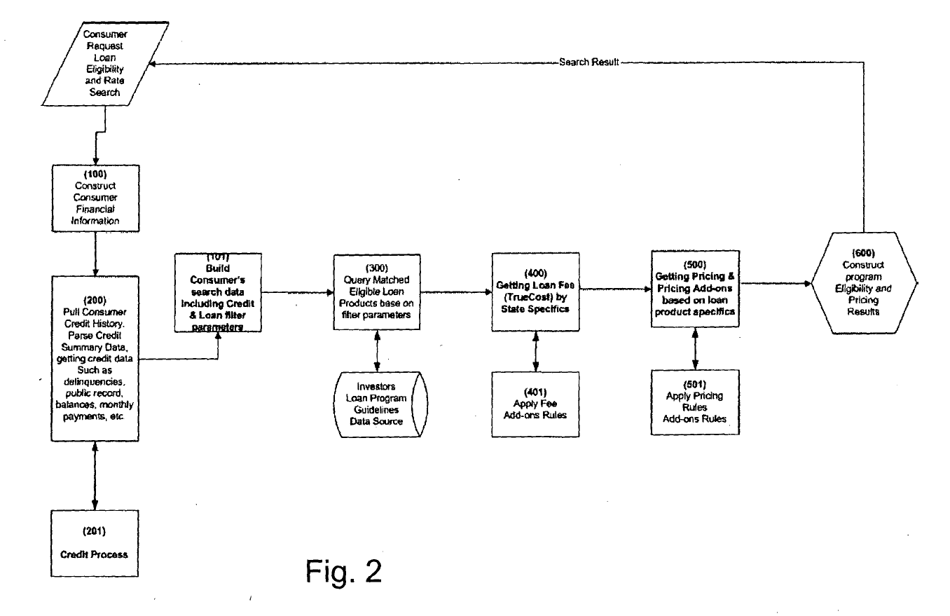

FIG. 2 shows in greater detail a flow chart of the process done by the second computer 3 in an embodiment of the invention. Upon receiving a consumer request for loan eligibility and rate search, the process begins by constructing a summary of consumer financial information in a standardized format (100). This information is used as the basis for creating a more detailed consumer-specific report (200), including collection (201) of a credit report, generally from a third-party information source, for example one or more credit agencies.

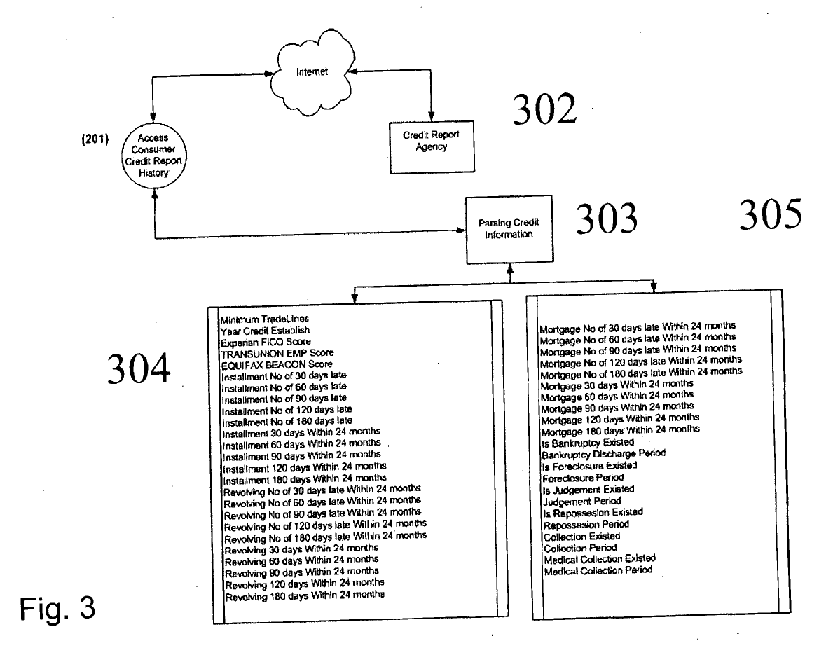

FIG. 3 shows a detail view of the credit history report collection process (201). Process (201) requests, for example via the internet information from a remote information source such as a credit reporting agency (302). The information is returned and is parsed by the processor (303) into ordered lists of information. Exemplary lists (304) and (305) are shown in FIG. 3, although the specific order and the specific information may vary from one embodiment to another.

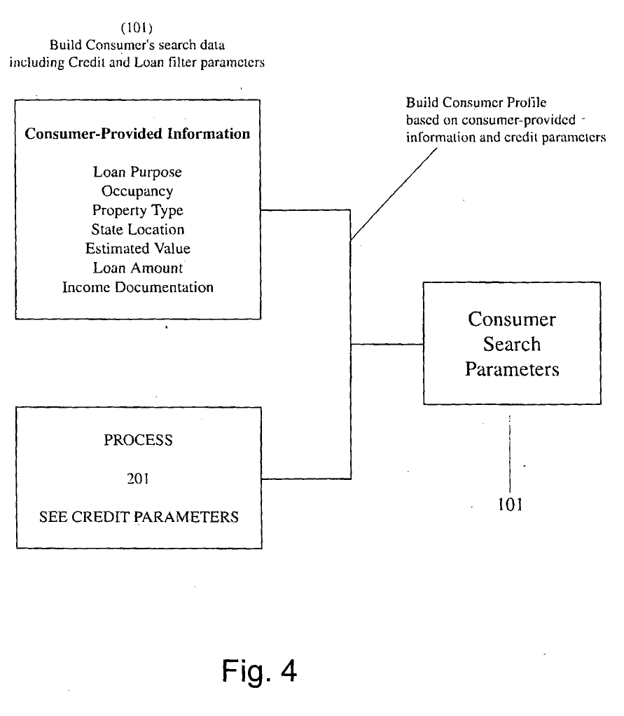

Looking again at FIG. 2, the collected information about the consumer's credit history and other information received from the consumer is used to build a set of consumer-specific search parameters (101). This process is shown in more detail in FIG. 4. Basically, the consumer-specific loan parameters (40) are combined with the consumer-specific credit parameters obtained in step (201) to yield a set of consumer-specific search parameters.

Once the search parameters (101) are determined for the consumer's request, they are matched to eligible loan programs (FIG. 2, 300). This process involves an item-by-item comparison of the information in the search parameters with the information in an investor's loan program guidelines (301 in FIG. 2) to arrive at a final subset of mortgage loan programs selected from a database containing a plurality of mortgage loan program listings. Preferably, this database contains at least 100 distinct mortgage loan programs, more preferably at least 1000 distinct mortgage loan programs. These mortgage loan programs are distinguished based on the characteristics in the search parameters list.

Those programs for which the consumer does not qualify are eliminated, and the final subset of available mortgage loan programs is identified for which the applicant does qualify. In some cases, one loan program for which the applicant qualifies may completely dominate another, for example when all terms and conditions but one are equal, in which case only the better of the two programs may be included in the final subset of available mortgages loan programs.

The elimination process is generally performed in multiple iterative steps, comparing one search parameter at a time against the loan program guidelines to establish successive intermediate subsets of mortgage loan programs. While the order in which these iterative steps are performed is not critical, it is desirable to perform the steps in a manner which generally minimizes the number of iterative steps. This can be accomplished by selecting for the initial comparisons those parameters which are most likely to eliminate the greatest numbers of mortgage loan programs. One method for accomplishing this is by consideration of parameters in the same order for all consumers, with the order being selected to be consistent with the mortgage loan programs available in the database. For example, if all of the mortgage loan programs are substantially nationwide in availability, then the state location is a parameter of little discriminatory value, and it would be considered later. On the other hand, if the mortgage loan programs tended to be ones available in only limited geographical regions, then the state location might well be a parameter considered early because it could eliminate many unavailable programs. Alternatively, one can utilize a consumer-specific evaluation order by rating each search parameter (for example as easy, moderate, or difficult) and searching those parameters with difficult ratings first.

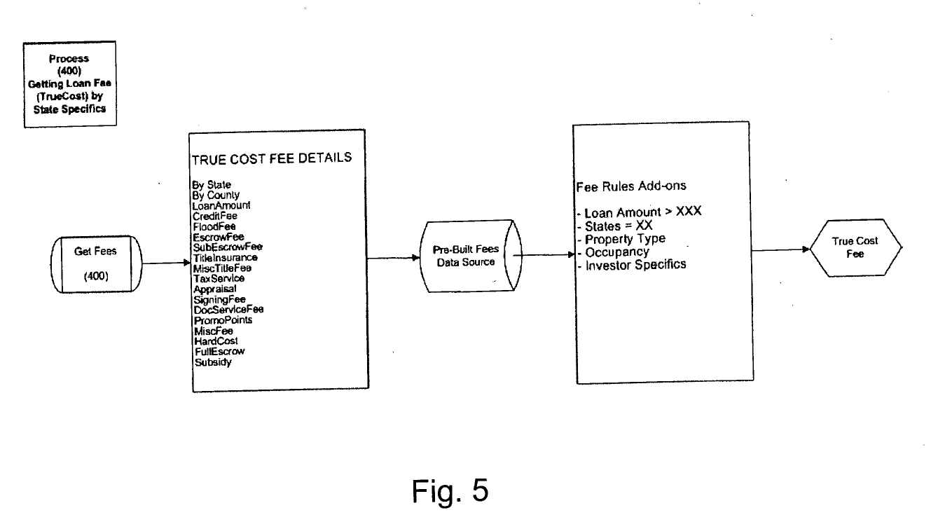

Once available loan programs are identified, the fees associated with each program can be determined for the specific consumer and transaction by application of defined fee and add-on rules (FIG. 2, 400, 401) to determine the actual cost of each loan program for the consumer. As reflected in FIG. 5, the loan fee may depend on the geographical location of the property, planned occupancy, requirements for escrow fees and title insurance, appraisals and the like. The pre-built fees database contains all of the lender fees charged by the lender for the mortgage program, including minimum fixed costs of third parties to close a loan in order to produce an accurate fee for typical loans, for example a Fannie Mae loan. The pre-built fees data base may also contain additional fees that may apply to a typical loans, and which are determined by the consumer-specific information. In general, there are four factors that may cause a fee add-on for a loan: (1) a loan amount above a certain threshold, (2) a property location, since some states require that attorney perform the closing which can increase the cost of the closing; (3) an unusual property type, and (4) unusual occupancy.

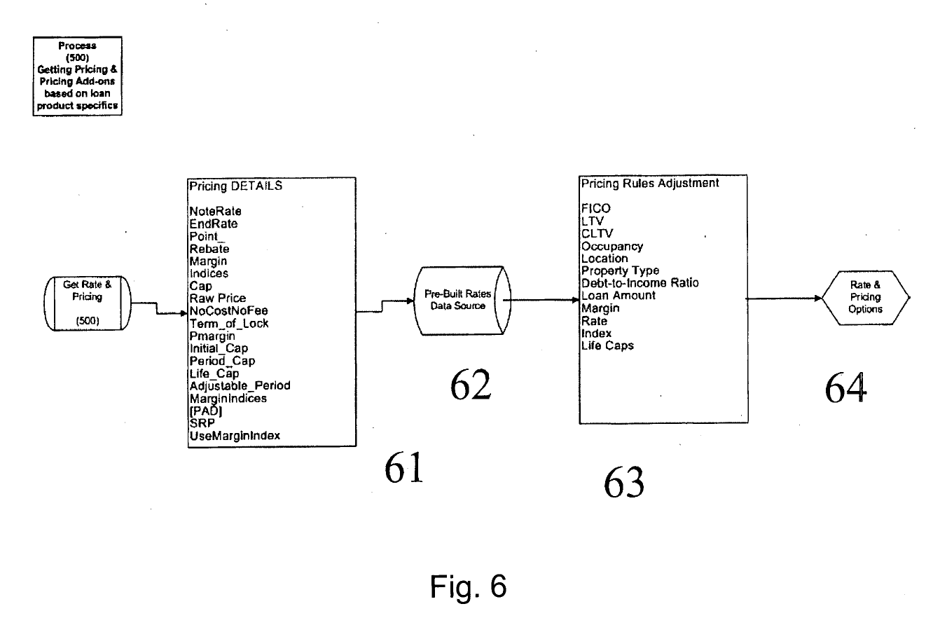

The final step (500) in FIG. 2 is the application of pricing adjustments. Pricing adjustments are optional, but will usually be done. Pricing adjustment may also be done prior to the determination of associated loan fees. The pricing adjustment program applies adjustments (up or down) from a base rate for such things as a high or low loan-to-value ratio or ajumbo or super-jumbo the amount to be financed. FIG. 6 notes pricing details 61 that may be adjusted through the application of a pre-built rate data source 62 in light of factors 63 to arrive at rate and pricing options 64 which are returned to the main program for application.

After selection of the subset of mortgage loan programs and any pricing adjustment that is required, the resulting information can be transmitted to the consumer at the first computer. In preferred embodiments of the invention, this transmission of the available mortgage loans is automatic and immediate. As used in the specification and claims of this application, the term “automatic”refers to processes that (in the absence of error or system failure) occur through the actions of computerized systems only, and without individual human intervention or analysis. The term “immediate” refers to processes which occur at speeds governed only by the involved computer processing and data transmission rates, and which are not delayed for human review or authorization. In general, subject to computer or system failure this means that a response will be received within minutes, for example within 20 minutes or less, preferably within 10 minutes or less and more preferably within 1 minute or less and opposed to the 24 hours period commonly quoted by businesses which purport to offer competitive mortgage bidding.

The subset of optionally-price-adjusted mortgage loan programs which is transmitted by the system and method of the invention provides the consumer with a real display of rates that are available to the particular to consumer, not an unrealistic advertising picture of teaser rates for which the consumer may not qualify. This allows the consumer to do meaningful comparison shopping between loan programs that are actually available to the consumer, and thus facilitates the selection of an appropriate mortgage loan program.

In a further embodiment of the invention, the information transmitted to the first computer for display also includes a statement of closing costs for the particular mortgage loan program. This statement of closing costs can be a “one-fee” program in which a flat stated fee is charged regardless of the actual expenses incurred in a particular closing, and regardless of the mortgage program selected. In other cases, the closing costs to be charged may depend on the mortgage loan program selected, in which case different closing cost amounts would be listed for each mortgage loan program in the selected subset.

In a further embodiment of the invention, when the closing costs are stated as part of the transmitted data as a guaranteed amount, the listing of the subset of mortgage loan programs constitutes an offer to the consumer to make a mortgage loan on the terms stated, subject only to the accuracy of the information provided by the consumer, including in particular, information about the nature and value of the property. In this embodiment of the invention, the consumer is given the opportunity to press a button to accept the loan as presented, and the loan application process is then complete. Loan paperwork based on the input information is then generated and sent to the consumer for signature, after which the loan is funded through the selected mortgage loan program.

Thus, in a first embodiment of the invention, there is provided a system for providing information about available mortgage loan programs to a consumer through an electronic communications network, comprising a first computer located at a first location accessible to the consumer; and a second computer system which is not directly accessible by the consumer, said first and second computer being connected to each other via the electronic communications network, wherein

(a) the second computer has access to a database of information of containing credit reports on consumers who may use the system;

(b) the second computer is programmed to direct the first computer to display a data collection display into which the consumer or other user acting on behalf of the consumer enters personal identification and financial information about the consumer;

(c) the second computer is programmed to receive information transmitted by the first computer from the data collection display and to obtain a credit report for the consumer;

(d) the second computer is programmed to process the credit report and any additional financial information received from the consumer to arrive at a credit worthiness value;

(e) the second computer has access to a database containing a listing of a plurality of mortgage loan programs, and is programmed to filter this database based on the credit worthiness value to generate a subset of mortgage loan programs for which the consumer qualifies; and

(f) the second computer is programmed to transmit a display of the subset of mortgage loan programs to the first computer, and

wherein all of the programmed actions of the second computer occur automatically in response to receipt of a transmission of a complete set of information from the first computer.

The invention further provides a method for providing information about available mortgage loan programs to a consumer through an electronic communications network, comprising the steps of

transmitting instructions from a second computer to a first computer located at a first location accessible to the consumer, wherein said instructions result in display of a data collection display into which the user enters personal identification and financial information about a consumer;

receiving via an electronic communication network at the second computer the personal identification and financial information of the consumer entered in the display using the first computer;

obtaining at the second computer a credit report for the consumer using the first computer;

processing in the second computer the credit report and any additional financial information received from the consumer to arrive at a credit worthiness value;

filtering a database containing a listing of a plurality of mortgage loan programs based on the credit worthiness value to generate a subset of mortgage loan programs for which the consumer qualifies; and

transmitting a display of the subset of mortgage loan programs to the first computer,

wherein all of the programmed actions of the second computer occur automatically in response to receipt of a transmission of a complete set of information from the first computer. The user and the consumer may be the same individual, or different individuals.

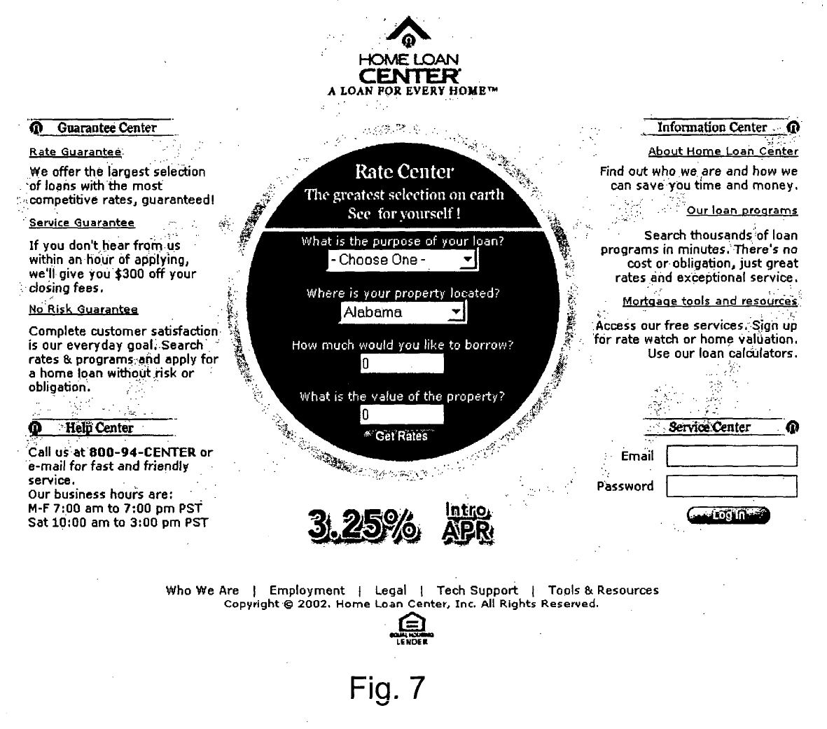

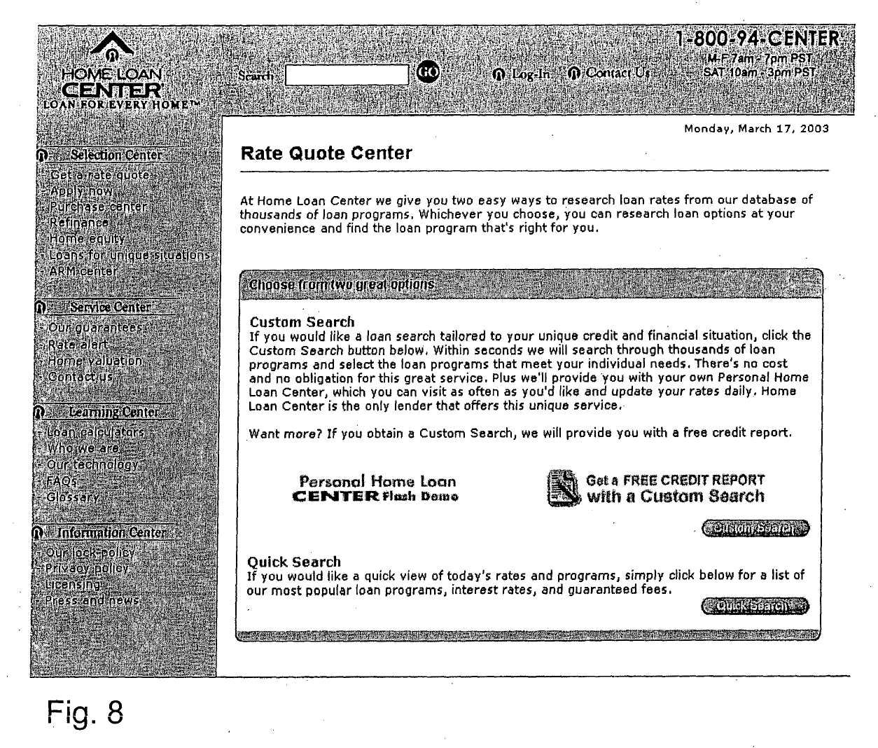

FIGS. 7-21 show various pages of a web-based data and information collection system which may be used in the method of the present invention. These pages are provided to illustrate one embodiment of the invention and by no means represent the only manner in which the method of the invention can be implemented. FIG. 7 shows the opening page of the system. As shown, the page has input locations for the purpose of the loan (i.e, purchase, refinance, refinance-cash out) (71), the state in which the property is located (72), the amount to be borrowed (73) and the value of the property (74). The page also contains a log in area (75) for use by returning customers/users. The page also includes links to non-consumer-specific information about available loan programs, the service provider and the like. Once the user inputs the information requested on this page, the next page (FIG. 8) shows a screen in which a choice is offered between a conventional quick search and a custom search in accordance with the invention.

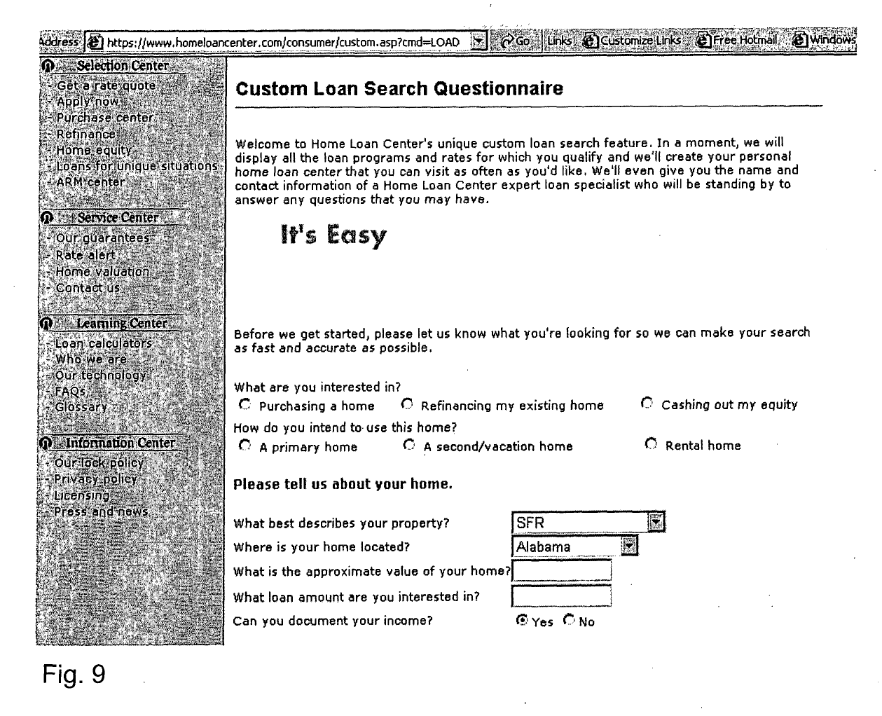

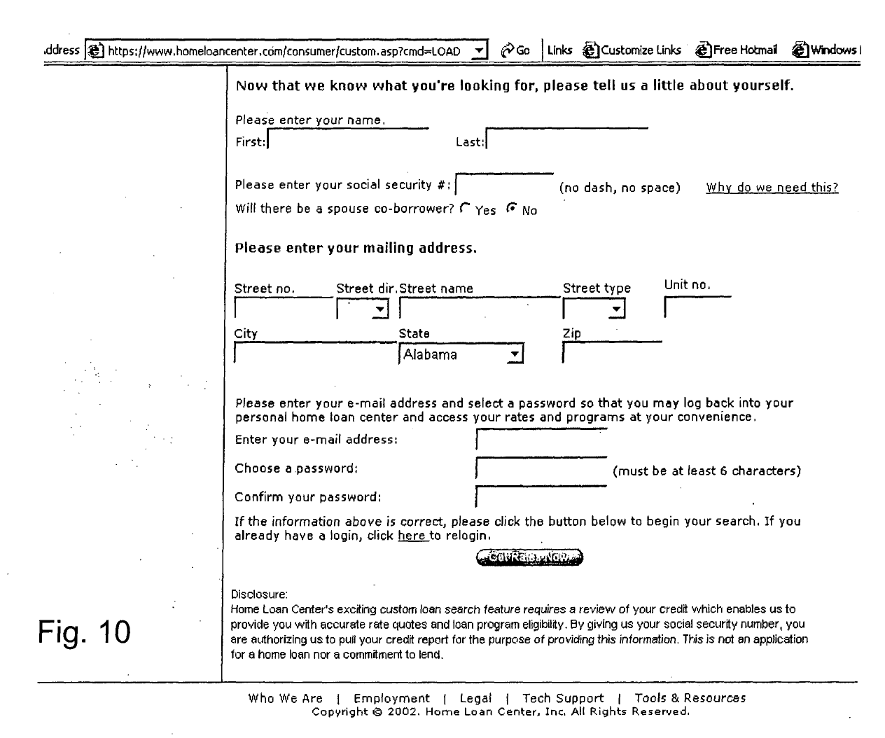

If the user selects the customer search, then FIGS. 9 and 10 show the next two pages of the web system in which basic customer information is collected (note that any information already provided by the user on a prior page will be auto-populated onto these pages). FIG. 10 also has entry fields for the creation of a user ID for immediate log in on subsequent visits.

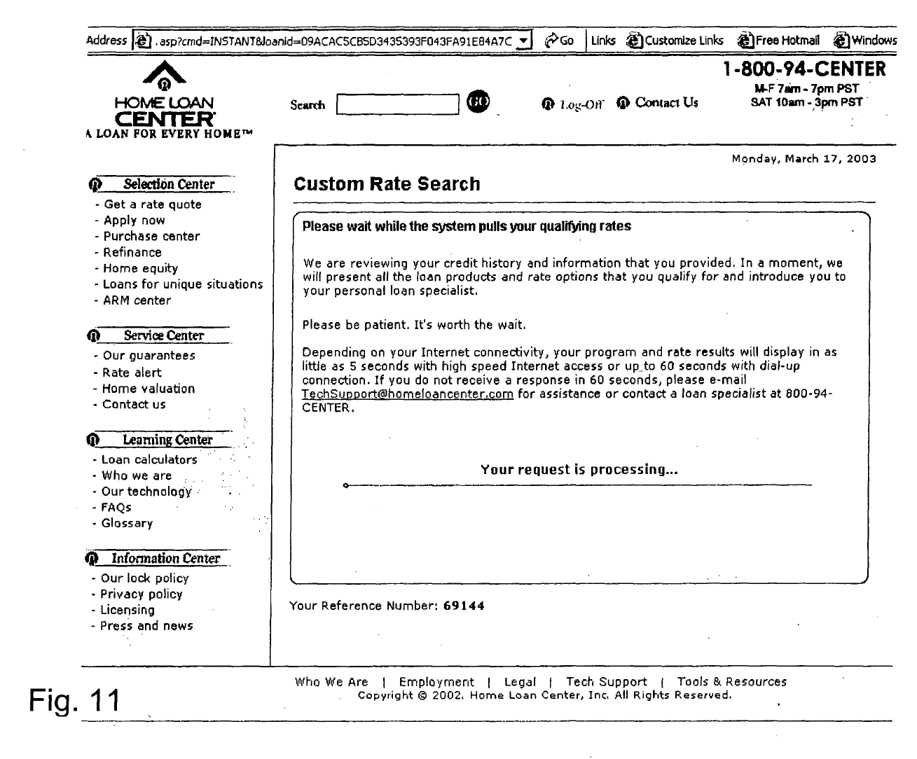

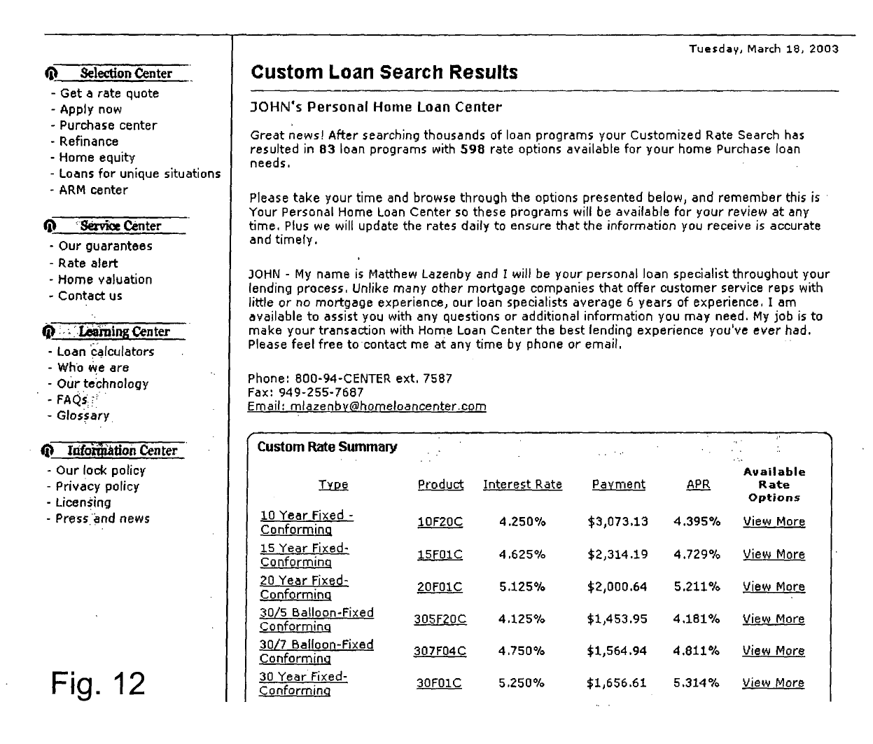

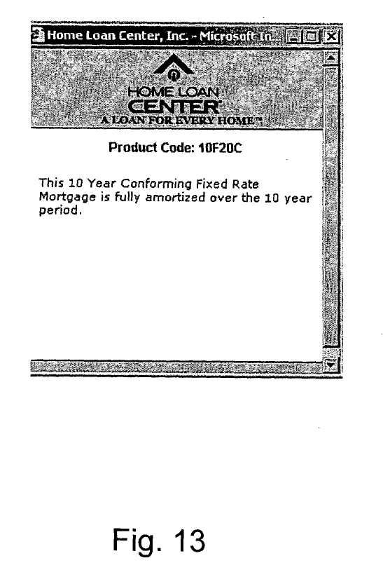

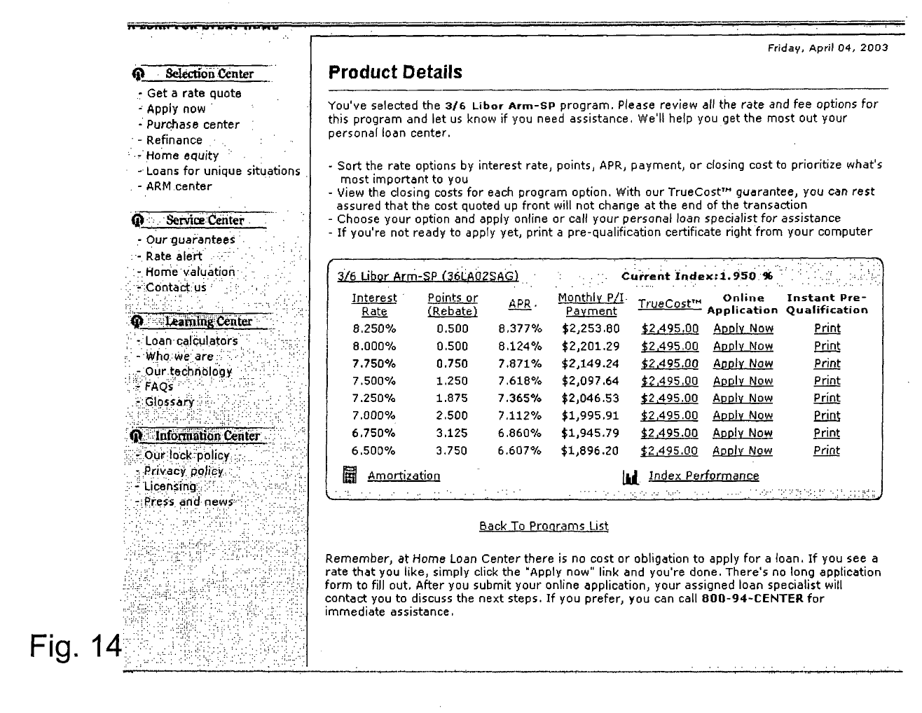

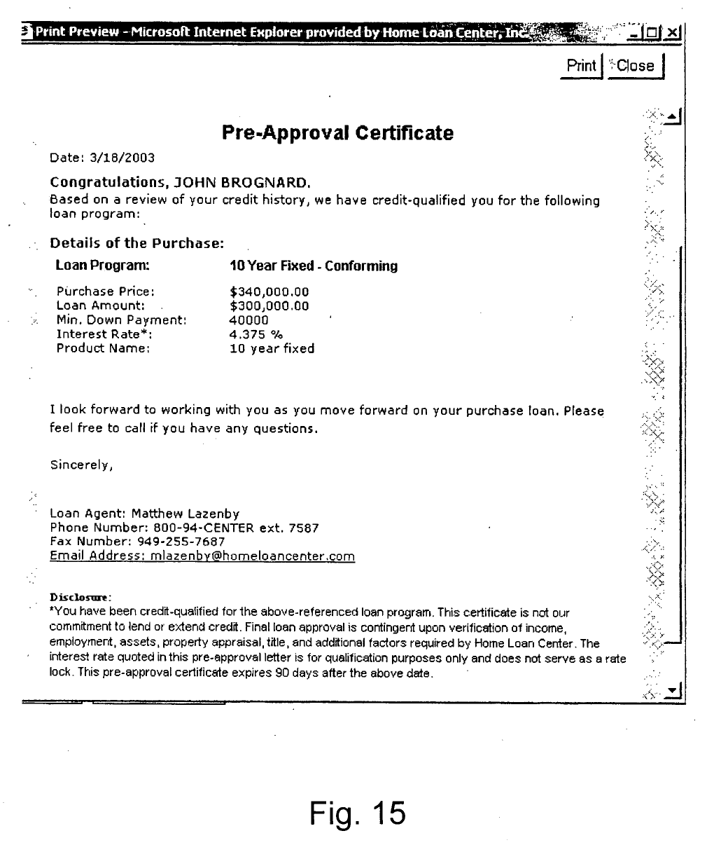

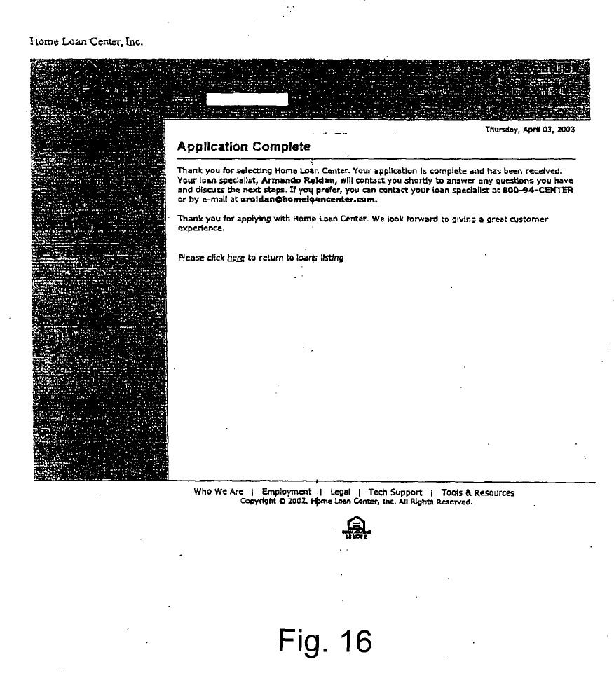

Once the user inputs the information requested on the pages shown in FIGS. 9 and 10 and indicates that he or she wants to proceed with the custom rate search, then the screen of FIG. 11 is displayed, showing that the evaluation is in progress. Within a very short time, generally in less than 60 seconds, a list of available loan programs is displayed, as shown in FIG. 12. In preferred embodiments, this display of available loan programs can be resorted into order by type, interest rate, APR, or payment by clicking on the corresponding column. Clicking the link in FIG. 12 in the “Type” or “Product” column displays a screen such as that shown in FIG. 13, which provides an explanation of the particular loan product to the consumer. Clicking the “View More” link in FIG. 12 in the “Available Rate Options” column displays a screen such as that shown in FIG. 14, which provides rate and point options within the loan program, and provides an option to “apply now” and an option to print a pre-approval certificate such as that shown in FIG. 15. If the consumer selects “apply now” on the screen shown in FIG. 14, then a screen such as that shown in FIG. 16 is displayed confirming that the user's application is complete and providing contact information regarding the loan specialist assigned to the application.

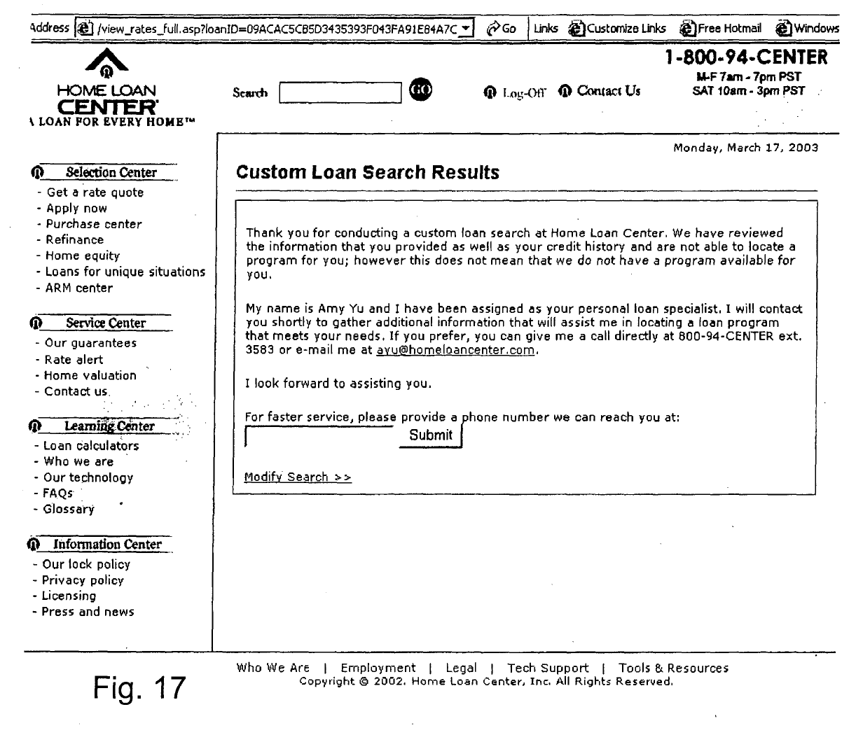

If the user inputs the information requests on the pages shown in FIGS. 9 and 10 and no loan programs are available based on such information, then FIG. 17 shows an example of the response provided to the consumer.

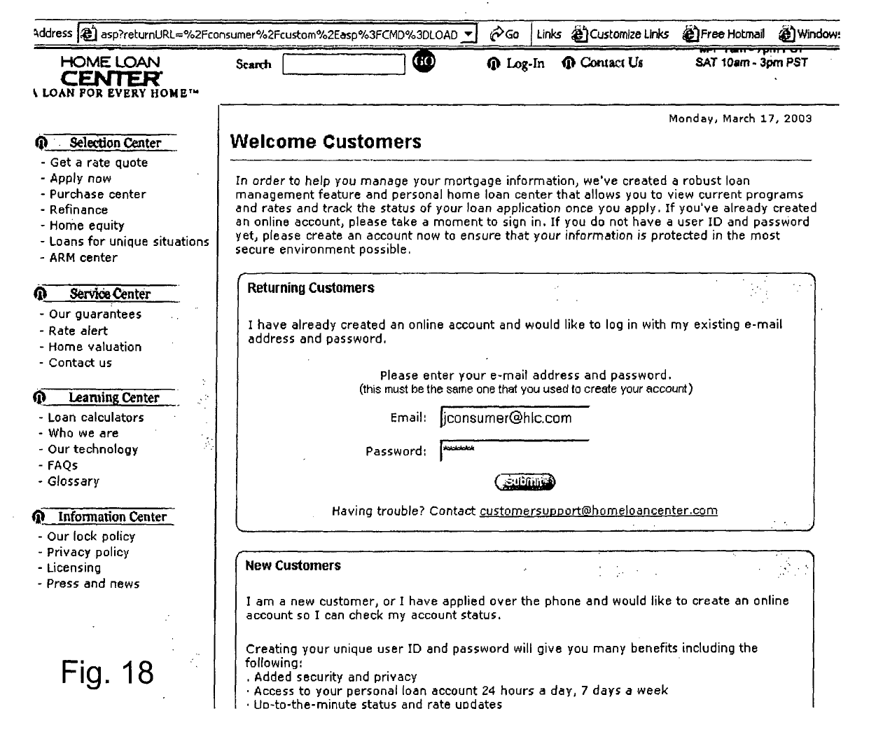

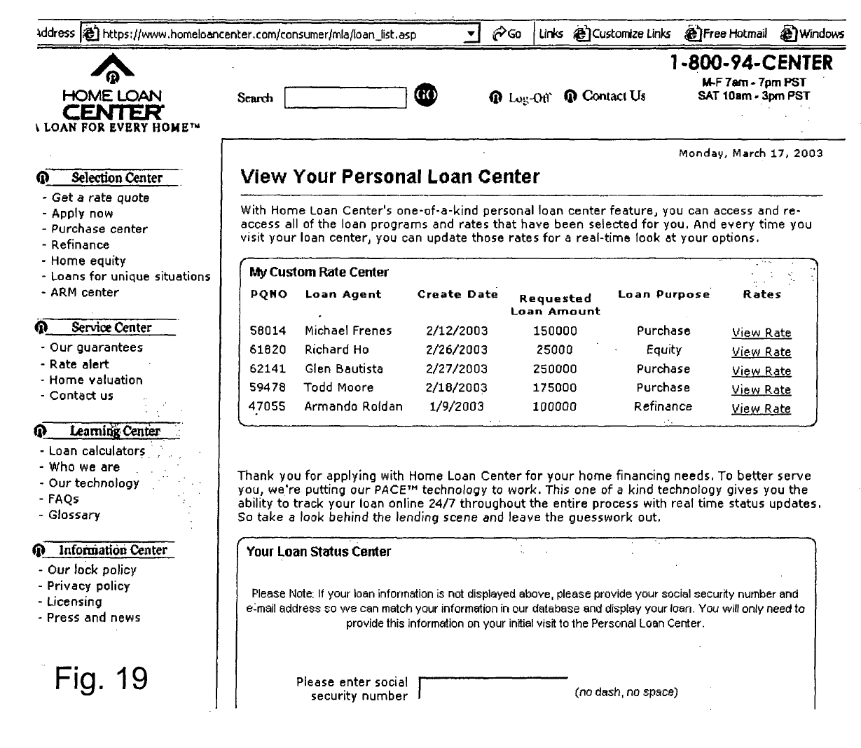

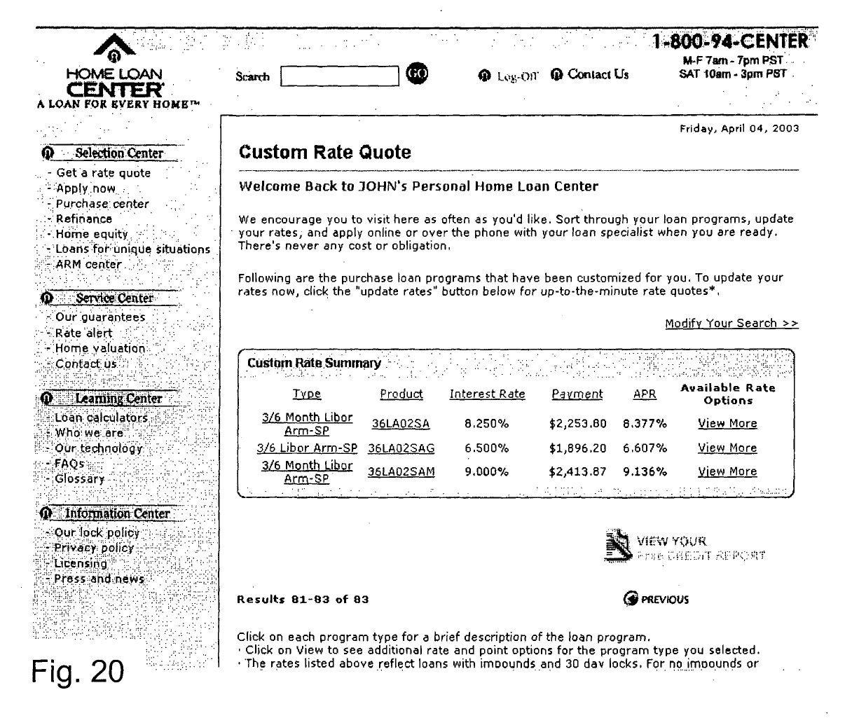

FIG. 18 shows an example of the page displayed to the user that has already conducted a custom rate search in a previous session and has returned to the website and accessed the log on feature shown in FIG. 7 (note that the log on feature is available from every page of the website). Once the consumer enters their log on information, the next page displayed is shown in FIG. 19. FIG. 19 displays all of the custom rate searches performed by the consumer. Clicking the link in FIG. 19 in the “Rates” column displays a screen such as that shown in FIG. 20. The screen in FIG. 20 is similar to the screen displayed to the consumer when they first performed the custom rate search (see FIG. 12). However, there is one additional function-a button that invites the user to “Update Rates.” If the user selects this option, then the system performs a new custom rate search and alters the data shown in FIG. 20 to reflect the programs available to the consumer at that moment.

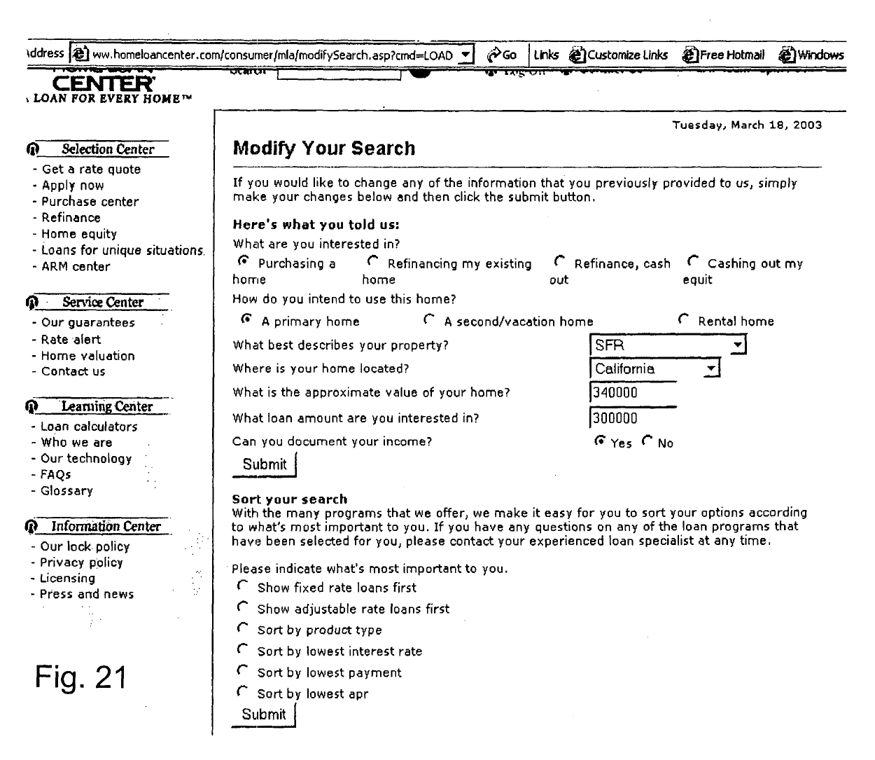

One final option available to the consumer (on the screens shown in FIG. 12 and FIG. 20) is a link allowing the consumer to modify his or her search parameters. Clicking the link titled “Modify your search” displays a screen such as that shown in FIG. 21, which allows the user to modify the information used by the system in performing the custom rate search.

What is claimed is:

1. A system for providing information about available mortgage loan programs to a consumer through an electronic communications network, comprising a first computer located at a first location accessible to the consumer; and a second computer system which is not directly accessible by the consumer, said first and second computer being connected to each other via the electronic communications network, wherein
(a) the second computer has access to a database of information of containing credit reports on consumers who may use the system;
(b) the second computer is programmed to direct the first computer to display a data collection display into which the consumer enters personal identification and financial information;
(c) the second computer is programmed to receive information transmitted by the first computer from the data collection display and to obtain a credit report for the consumer;
(d) the second computer is programmed to process the credit report and any additional financial information received from the consumer to arrive at a credit worthiness value;
(e) the second computer has access to a database containing a listing of a plurality of mortgage loan programs, and is programmed to filter this database based on the credit worthiness value to generate a subset of mortgage loan programs for which the consumer qualifies; and
(f) the second computer is programmed to transmit a display of the subset of mortgage loan programs to the first computer, and
wherein all of the programmed actions of the second computer occur automatically in response to receipt of a transmission of a complete set of information from the first computer.

2. The system according to claim 1, wherein the database containing a listing of mortgage loan programs contains listings for at least 100 distinct mortgage loan programs.

3. The system according to claim 1, wherein the database containing a listing of mortgage loan programs contains listings for at least 1000 distinct mortgage loan programs.

4. The system according to claim 1, wherein the database containing a listing of mortgage loan programs is stored on a storage device locally associated with the second computer.

5. The system according to claim 4, wherein the database containing a listing of mortgage loan programs contains listings for at least 100 distinct mortgage loan programs.

6. The system according to claim 4, wherein the database containing a listing of mortgage loan programs contains listings for at least 1000 distinct mortgage loan programs.

7. The system according to claim 1, wherein the second computer applies a price adjustment to interest rates associated with each of the mortgage loan programs in the subset of mortgage loan programs to take into account the size of the loan, the loan-to-value ratio, or both prior to transmission of the listing to the first computer.

8. The system according to claim 7, wherein the database containing a listing of mortgage loan programs contains listings for at least 100 distinct mortgage loan programs.

9. The system according to claim 7, wherein the database containing a listing of mortgage loan programs contains listings for at least 1000 distinct mortgage loan programs.

10. The system according to claim 1, wherein the second computer generates a closing cost for each mortgage loan program in the subset of mortgage loan programs, and includes this closing cost in the display transmitted to the first computer.

11. The system according to claim 10, wherein the closing costs are the same for each mortgage loan program.

12. The system according to claim 11, wherein the database containing a listing of mortgage loan programs contains listings for at least 100 distinct mortgage loan programs.

13. The system according to claim 11, wherein the database containing a listing of mortgage loan programs contains listings for at least 1000 distinct mortgage loan programs.

14. The system according to claim 10, wherein the second computer applies a price adjustment to interest rates associated with each of the mortgage loan programs in the subset of mortgage loan programs to take into account the size of the loan, the loan-to-value ratio, or both prior to transmission of the listing to the first computer.

15. The system according to claim 14, wherein the database containing a listing of mortgage loan programs contains listings for at least 100 distinct mortgage loan programs.

16. The system according to claim 14, wherein the database containing a listing of mortgage loan programs contains listings for at least 1000 distinct mortgage loan programs.

17. The system of claim 10, wherein the display of the subset of mortgage loan programs on the first computer constitutes an offer of a mortgage loan which can be accepted by the consumer without further credit approval.

18. The system according to claim 17, wherein the closing costs are the same for each mortgage loan program.

19. The system according to claim 18, wherein the database containing a listing of mortgage loan programs contains listings for at least 100 distinct mortgage loan programs.

20. The system according to claim 18, wherein the database containing a listing of mortgage loan programs contains listings for at least 1000 distinct mortgage loan programs.

21. The system according to claim 17, wherein the second computer applies a price adjustment to interest rates associated with each of the mortgage loan programs in the subset of mortgage loan programs to take into account the size of the loan, the loan-to-value ratio, or both prior to transmission of the listing to the first computer.

22. The system according to claim 21, wherein the database containing a listing of mortgage loan programs contains listings for at least 100 distinct mortgage loan programs.

23. The system according to claim 21, wherein the database containing a listing of mortgage loan programs contains listings for at least 1000 distinct mortgage loan programs.

24. The system of claim 1, whereinall of the programmed actions of the second computer occur immediately in response to receipt of a transmission of a complete set of information from the first computer.

25. A method for providing information about available mortgage loan programs to a consumer through an electronic communications network, comprising the steps of
transmitting instructions from a second computer to a first computer located at a first location accessible to the consumer, wherein said instructions result in display of a data collection display into which the consumer enters personal identification and financial information;
receiving via an electronic communication network at the second computer the personal identification and financial information entered in the display by the consumer using the first computer;
obtaining at the second computer a credit reports for the consumers using the first computer;
processing in the second computer the credit report and any additional financial information received from the consumer to arrive at a credit worthiness value;
filtering a database containing a listing of a plurality of mortgage loan programs based on the credit worthiness value to generate a subset of mortgage loan programs for which the consumer qualifies; and
transmitting a display of the subset of mortgage loan programs to the first computer,
wherein all of the programmed actions of the second computer occur automatically in response to receipt of a transmission of a complete set of information from the first computer.

26. The method according to claim 25, wherein the database containing a listing of mortgage loan programs contains listings for at least 100 distinct mortgage loan programs.

27. The method according to claim 25, wherein the database containing a listing of mortgage loan programs contains listings for at least 1000 distinct mortgage loan programs.

28. The method according to claim 25, wherein the database containing a listing of mortgage loan programs is stored on a storage device locally associated with the second computer.

29. The method according to claim 28, wherein the database containing a listing of mortgage loan programs contains listings for at least 100 distinct mortgage loan programs.

30. The method according to claim 28, wherein the database containing a listing of mortgage loan programs contains listings for at least 1000 distinct mortgage loan programs.

31. The method according to claim 26, wherein the second computer applies a price adjustment to interest rates associated with each of the mortgage loan programs in the subset of mortgage loan programs to take into account the size of the loan, the loan-to-value ratio, or both prior to transmission of the listing to the first computer.

32. The method according to claim 31, wherein the database containing a listing of mortgage loan programs contains listings for at least 100 distinct mortgage loan programs.

33. The method according to claim 31, wherein the database containing a listing of mortgage loan programs contains listings for at least 1000 distinct mortgage loan programs.

34. The method according to claim 25, wherein the second computer generates a closing cost for each mortgage loan program in the subset of mortgage loan programs, and includes this closing cost in the display transmitted to the first computer.

35. The method according to claim 34, wherein the closing costs are the same for each mortgage loan program.

36. The method according to claim 35, wherein the database containing a listing of mortgage loan programs contains listings for at least 100 distinct mortgage loan programs.

37. The method according to claim 35, wherein the database containing a listing of mortgage loan programs contains listings for at least 1000 distinct mortgage loan programs.

38. The method according to claim 34, wherein the second computer applies a price adjustment to interest rates associated with each of the mortgage loan programs in the subset of mortgage loan programs to take into account the size of the loan, the loan-to-value ratio, or both prior to transmission of the listing to the first computer.

39. The method according to claim 38, wherein the database containing a listing of mortgage loan programs contains listings for at least 100 distinct mortgage loan programs.

40. The method according to claim 38, wherein the database containing a listing of mortgage loan programs contains listings for at least 1000 distinct mortgage loan programs.

41. The method of claim 34, wherein the display of the subset of mortgage loan programs on the first computer constitutes an offer of a mortgage loan which can be accepted by the consumer without further credit approval.

42. The method according to claim 41, wherein the closing costs are the same for each mortgage loan program.

43. The method according to claim 42, wherein the database containing a listing of mortgage loan programs contains listings for at least 100 distinct mortgage loan programs.

44. The method according to claim 42, wherein the database containing a listing of mortgage loan programs contains listings for at least 1000 distinct mortgage loan programs.

45. The method according to claim 41, wherein the second computer applies a price adjustment to interest rates associated with each of the mortgage loan programs in the subset of mortgage loan programs to take into account the size of the loan, the loan-to-value ratio, or both prior to transmission of the listing to the first computer.

46. The method according to claim 45, wherein the database containing a listing of mortgage loan programs contains listings for at least 100 distinct mortgage loan programs.

47. The method according to claim 45, wherein the database containing a listing of mortgage loan programs contains listings for at least 1000 distinct mortgage loan programs.

48. The method of claim 25, wherein all of the programmed actions of the second computer occur immediately in response to receipt of a transmission of a complete set of information from the first computer.
